(19) United States
(12) Patent Application Publication
(10) Pub. No.: US 2003/0222761 A1
(43) Pub. Date: Dec. 4, 2003

(54) Induction type electronic lock

(76) Inventor: Ming Cheng Wang, Taipei (TW)

Correspondence Address: Ming Cheng Wang, PO Box 82-144, Taipei, TW

(21) Appl. No.: 10/156,121

(22) Filed: May 29, 2002

(51) Int. Cl. G05B 19/00

(52) U.S. Cl. 340/5.74; 710/200

(57) ABSTRACT

A induction type electronic lock is constructed to include a compact disk having a data storage side storing a CD code and a code verification program and attached data storage means storing an electronic code, and a sensor installed in a CD-ROM player of a computer system and adapted for scanning the electronic code of the attached data storage means for enabling the scanned electric code to be verified by the code verification program fetched by the CPU of the computer system from the compact disk.

### BACKGROUND OF THE INVENTION

1. Field of the Invention

The present invention relates to an electronic lock adapted for use in a computer system to prohibit unauthorized people from copying the software of the computer system and, more particularly, to an induction type electronic lock, which comprises a CD having an electronic code stored in an attached storage means, and a sensor installed in the CD-ROM player of the computer system for reading and verifying the electronic code for controlling the access to the software program of the computer system.

2. Description of the Related Art

A computer software program creator usually will add a code to the program to prohibit others from copying the program. However, after the legal user installed the software program in a computer, other people can still copy the software program from the computer easily without the permission of the legal user. Various electronic locks have been disclosed for prohibiting other people from copying computer software programs illegally, and have appeared on the market. However, conventional electronic locks can only protect software programs that are not boosted or before the boosting of the computer. After initiation of the protected software program, any people can copy the software program. If the user left the computer temporarily at this time, other people can then copy the software program from the computer illegally. In order to eliminate this problem, electronic locks are developed. FIG. 1 shows the arrangement of an electronic lock according to the prior art. According to this arrangement, the electronic lock comprises an encoder card A mountable to an optical mouse. The encoder card A comprises an electronic encoder circuit, which is electrically connected to the mouse circuit of the optical mouse after insertion of the encoder card A into the matching interface socket in the optical mouse. After insertion of the encoder card A into the interface socket inside the optical mouse, the user runs an operational procedure to encrypt the software in the computer to which the optical mouse is connected. The encryption includes “CD code” and “verification program”. When copying a software program from the computer system, as shown in FIG. 2, the user must insert the encoder card into the interface socket of the optical mouse, enabling the encoder circuit of the encoder card to be inputted into the computer. Thereafter, the user must insert the CD (or diskette) having “code verification program” stored therein into the CD-ROM player (or diskdrive) of the computer, enabling the computer to run the code verification program to verify the authenticity of the electronic code received from the encoder card. When the electronic code proved to be correct, the copying action is allowed. If the electronic code rejected, the copying action is prohibited. Therefore, the user can take the encoder card away from the optical mouse before leaving the computer, preventing other people from copying the software programs from the computer illegally.

### SUMMARY OF THE INVENTION

The present invention has been accomplished under the circumstances in view. According to the present invention, the induction type electronic lock comprises a CD-ROM player readable CD, and a sensor installed in a CD-ROM player. The CD has a data storage side storing a CD code and a code verification program and attached data storage means storing an electronic code, which controls access to the software programs of the computer system. The attached data storage means can be an IC chip or disk. The sensor is adapted for scanning the electronic code of the attached data storage means for enabling the scanned electric code to be verified by the code verification program fetched by the CPU of the computer system from the CD. When the user removed the CD from the CD-ROM player, the software programs of the computer system are automatically locked.

### BRIEF DESCRIPTION OF THE DRAWINGS

FIG. 1 is a block diagram explaining the arrangement of an electronic lock according to the prior art.

FIG. 2 is a flow chart explaining the unlocking action of the electronic lock according to the prior art.

FIG. 3 is a flow chart showing the operation of an induction type electronic lock according to the present invention.

FIG. 4 is an exploded view of a CD for the induction type electronic lock according to the second embodiment of the present invention.

FIG. 5 is an assembly view of the CD shown in FIG. 4.

FIG. 6 is a sectional view in an enlarged scale of a part of the CD shown in FIG. 5.

FIG. 7 is a sectional view showing the CD inserted into the CD-ROM player and the sensor aimed at the IC chip (or disk) according to the present invention.

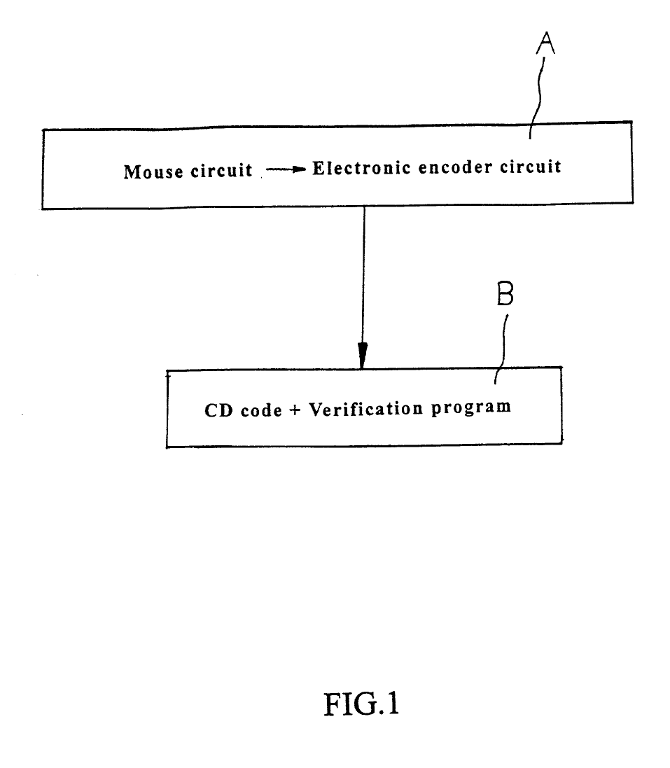

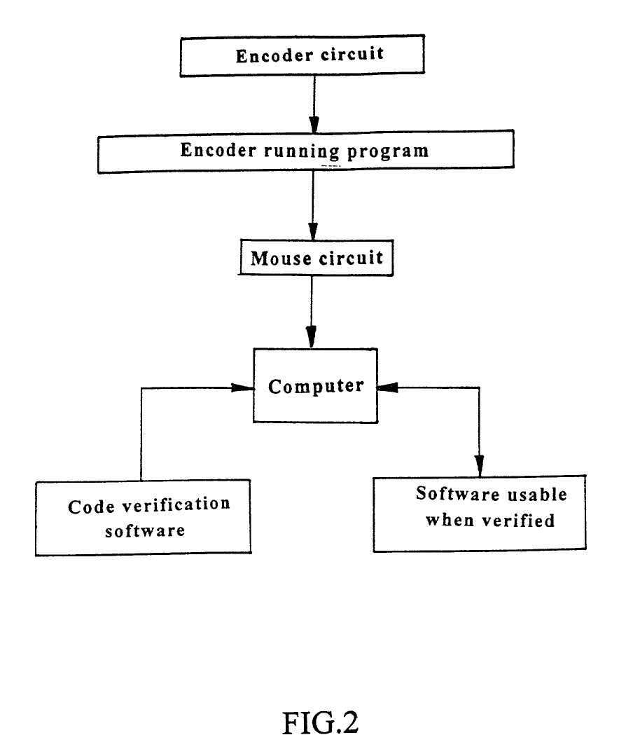

### DETAILED DESCRIPTION OF THE PREFERRED EMBODIMENT

Referring to FIGS. from 3 through 7, an induction type electronic lock in accordance with one embodiment of the present invention is shown comprised of a CD 1 and a sensor 2. The CD 1 comprises an annular groove 11 on the data storage side around the center spindle hole thereof, an annular mount 12 fastened to the annular groove 11 in a flush manner, the annular mount 82 having a recessed portion 121 in the top surface thereof, and an IC chip (or disk) 13 fastened to the recessed portion 121 and disposed in flush with the top surface of the annular mount 12. The sensor 2 is installed in a CD-ROM player (or diskdrive) 3. The operation of this embodiment is outlined hereinafter. When the CD 1 inserted into the CD-ROM player (or diskdrive) 2, the CPU of the host computer (not shown) reads in the CD code and verification program from the CD 1 and then runs the program, and at the same time the sensor 2 scans the electronic code stored in the IC chip (or disk) 13 for enabling the scanned data to be verified by the code verification program. If the electronic code rejected, the host computer is stopped from opening the software. If the electronic code verified, the code verification program informs the CPU of the host computer to open the software of the host computer, enabling the user to operate the software and to copy the software. Before leaving, the user can take the CD 1 away from the computer, keeping the software of the computer locked.

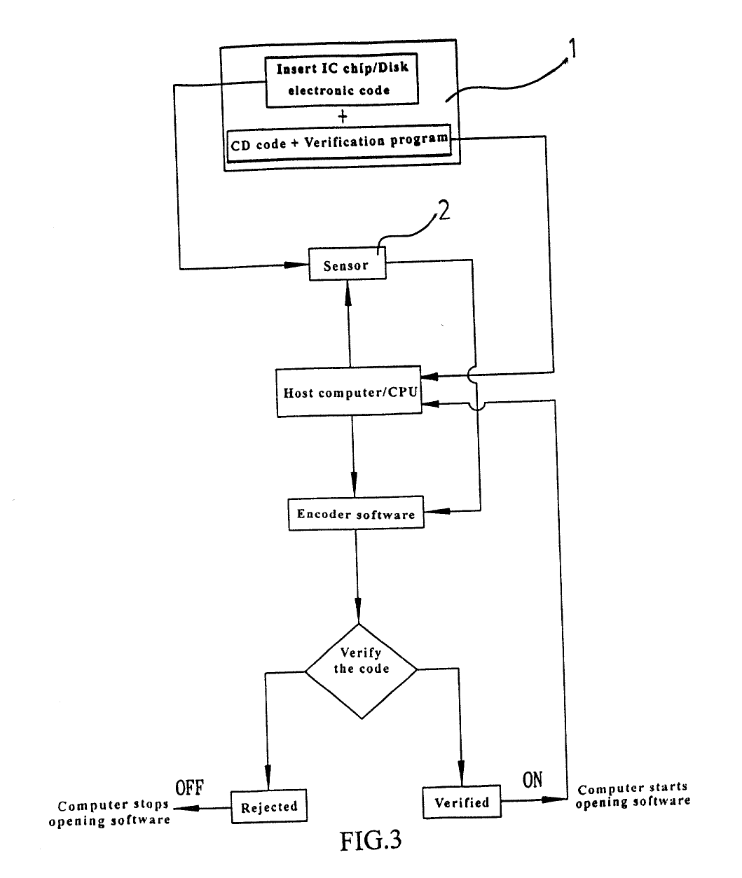

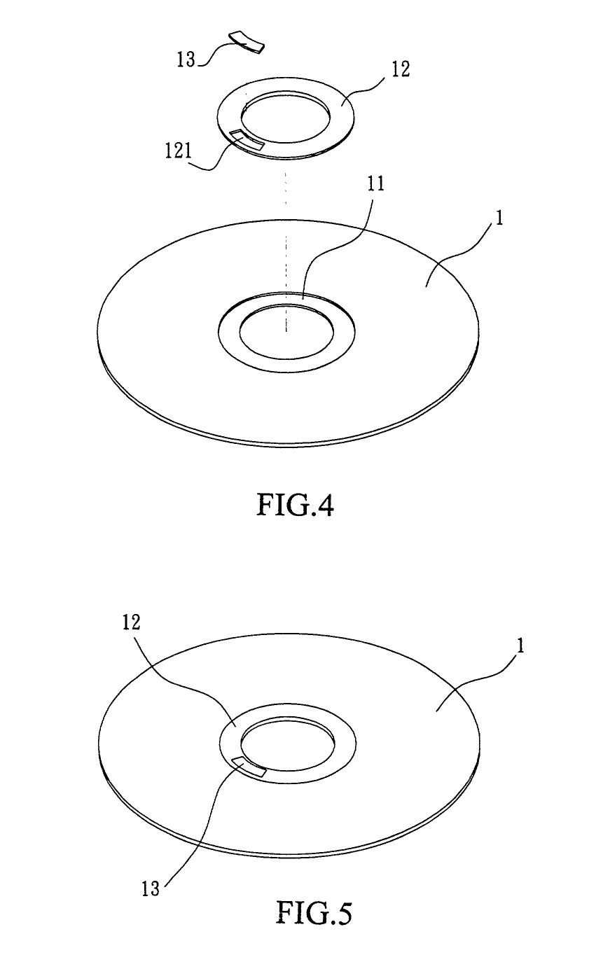

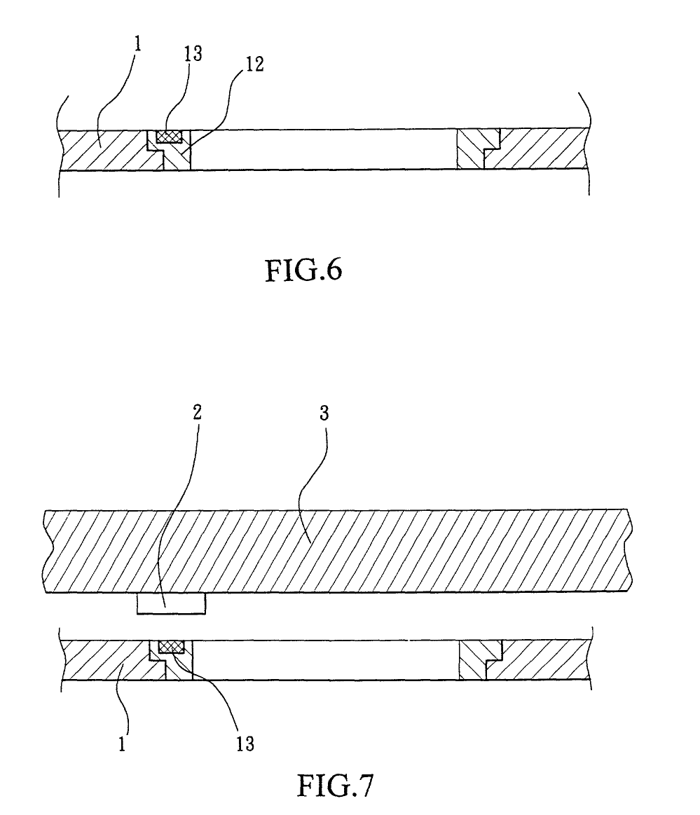

A prototype of induction type electronic lock has been constructed with the features of the annexed drawings of FIGS. 3˜7. The induction type electronic lock functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An induction type electronic lock comprising a compact disk and a sensor, said compact disk having a data storage side storing a CD code and a code verification program and an attached data storage means, said attached data storage means storing an electronic code, said sensor been installed in a CD-ROM player of a computer system and adapted for scanning the electronic code of said attached data storage means for enabling the scanned electric code to be verified by the code verification program fetched by the CPU of said computer system from said compact disk.

2. The induction type electronic lock as claimed in claim 3, wherein said compact disk comprises an annular groove disposed in said data storage side, an annular mount fastened to said annular groove in a flush manner, said annular mount having a recessed portion disposed in a top surface thereof and holding said attached data storage means in a flush manner.
